(19) United States
(12) Patent Application Publication
(10) Pub. No.: US 2019/0289708 A1
(43) Pub. Date: Sep. 19, 2019

(54) MULTI-ELECTRODE PLASMA TORCH

(71) Applicant: KOREA HYDRO & NUCLEAR POWER CO., LTD., Gyeongsangbuk-do (KR)

(72) Inventors: Hyun Je CHO, Daejeon (KR); Seok Ju HWANG, Daejeon (KR)

(21) Appl. No.: 16/464,908

(22) PCT Filed: Nov. 24, 2017
(86) PCT No.: PCT/KR2017/013505

§ 371 Date: May 29, 2019

(30) Foreign Application Priority Data
Nov. 30, 2016 (KR) 10-2016-0161742

(51) Int. Cl. H05H 1/34; H05H 1/42; H05H 1/28

(52) U.S. Cl. CPC H05H 1/34; H05H 2001/3452; H05H 1/28; H05H 1/42

(57) ABSTRACT

A multi-electrode plasma torch (10) a rear electrode (100), a front electrode (200), and a plurality of electrode plates (300) disposed between the rear electrode and front electrode. Among the plurality of electrode plates is an auxiliary electrode plate (400), adjacent to the rear electrode and with a polarity opposite to a polarity of the rear electrode. A power supply unit (500) is connected between the rear electrode and the auxiliary electrode plate for supplying power.

### TECHNICAL FIELD

The present invention relates to a multi-electrode plasma torch. More particularly, the present invention relates to a multi-electrode plasma torch capable of increasing the length of an arc.

### BACKGROUND ART

In conventional rod-nozzle or cavity torches, the entire inner surface of a given nozzle-type or cavity-type electrode is constructed as a single conductor that can accept an arc current anywhere. An arc spot freely can be moved across the entire inner surface of an electrode, and the length of an arc formed between the anode and the cathode can be controlled within the electrode conductor length range by controlling operating conditions such as an arc current and a gas flow rate. For example, when the gas flow rate is increased, the arc spot is pushed by the gas flow, and accordingly the arc length and the arc voltage can be increased. In this case, however, an increase in arc length is limited by the length of a given electrode conductor, which is determined depending on a nozzle type or a cavity type. When the arc current is increased, the arc length is reduced by the Lorentz force or the like.

Meanwhile, in order to lower the discharge voltage of the plasma gas used, the DC pulse frequency is raised in a vacuum condition for ignition. However, when a large number of gaps are inserted to increase the output and the distance between the electrodes is excessively long, the initial discharge for plasma arc generation is difficult even with the DC pulse frequency being increased. Even if the discharge occurs, since an application voltage across the electrode is high due to the long distance between the electrodes, it is difficult to achieve an early-stage low output operation.

### DOCUMENT OF RELATED ART

Korean Patent No. 10-0486939 (as of May 3, 2005)

### DISCLOSURE

### Technical Problem

The present invention has been made in view of the problems occurring in the related art and an object of the present invention is to provide a device in which multiple electrode plates are installed to increase an arc length.

### Technical Solution

In order to achieve the object of the invention, according to an aspect of the present invention, there is provided a multi-electrode plasma torch including: a rear electrode; a front electrode; multiple electrode plates disposed between the rear electrode and the front electrode; an auxiliary electrode plate which is adjacent to the rear electrode and is opposite in polarity to the rear electrode, the auxiliary electrode plate being one of the multiple electrode plates; and a power supply unit connected between the rear electrode and the auxiliary electrode plate to supply electric power.

Preferably, the electrode plate may be of a disk form, and the electrode plates are sealed and coupled each other.

Preferably, an external circumferential surface of each of the electrode plates may be connected to a cooling water pipe through which cooling water is supplied, a gas pipe through which gas is supplied, and a power pipe through which electric power is supplied to the electrode plate to serve as an electrode, wherein the cooling water pipe, the gas pipe, and the power pipe are spaced at predetermined intervals.

Preferably, the power supply unit may further include a switch for switching between the auxiliary electrode and the front electrode to electrically isolate the auxiliary electrode when required.

### Advantageous Effects

The multi-electrode plasma torch of the present invention can increase an arc length by having multiple electrode plates, facilitates an initial ignition of a torch by naturally forming an arc column between an anode and a cathode, and easily control the output from a relatively low power to a relatively high power.

### DESCRIPTION OF DRAWINGS

FIG. 1 is a partial cross-sectional view of a multi-electrode plasma torch according to one embodiment of the present invention;

FIG. 2 is a view illustrating a process of assembling electrode plates according to one embodiment of the present invention;

FIG. 3 is a perspective view of the multi-electrode plasma torch according to the embodiment of the present invention;

FIG. 4 is a side elevation view of the electrode plates of the multi-electrode plasma torch according to the embodiment of the present invention; and

FIG. 5 is a cross-sectional view of the multi-electrode plasma torch according to the embodiment of the present invention.

### BEST MODE

In the following description, the specific structural or functional descriptions for exemplary embodiments according to the concept of the present disclosure are merely for illustrative purposes and those skilled in the art will appreciate that various modifications and changes to the exemplary embodiments are possible, without departing from the scope and spirit of the present invention. Therefore, the present invention is intended to cover not only the exemplary embodiments but also various alternatives, modifications, equivalents, and other embodiments that may be included within the spirit and scope of the embodiments as defined by the appended claims.

Hereinbelow, exemplary embodiments of the present disclosure will be described in detail with reference to the accompanying drawings.

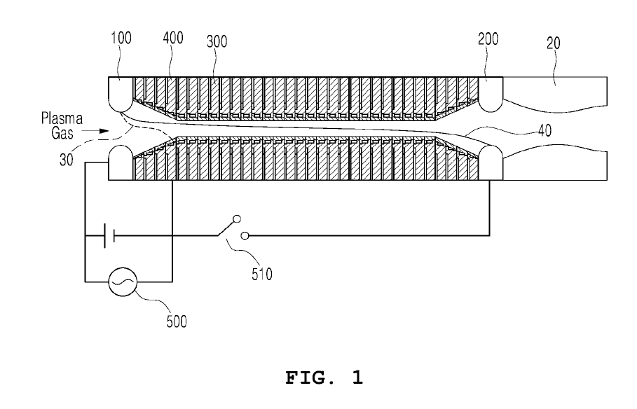

FIG. 1 is a partial cross-sectional view of a multi-electrode plasma torch according to one embodiment of the present invention.

Referring to FIG. 1, a multi-electrode plasma torch includes: a rear electrode 100; a front electrode 200; multiple electrode plates 300 disposed between the rear electrode 100 and the front electrode 200; an auxiliary electrode plate 400 that is one of the multiple electrode plates, is closer to the rear electrode 100 than the front electrode, and is opposite in polarity to the rear electrode 100; and a power supply unit 500 connected between the rear electrode 100 and the auxiliary electrode plate 400 to supply electric power.

Hereinafter, for better understanding, the rear electrode 100, the front electrode 200, and the auxiliary electrode plate 400 are referred to as the positive electrode (or anode) 100, the negative electrode (or cathode) 200, and the auxiliary negative electrode plate (or auxiliary cathode plate) 400, respectively.

Each of the positive electrode 100 and the negative electrode 200 has a ring shape. The positive electrode 100 and the auxiliary negative electrode plate 400 are disposed coaxially to maximize the surface area of the opposing sides thereof. This arrangement facilitates stably forming an arc column 30 at an initial discharge stage.

The electrode plates 300 are each in the form of a disk. A stack of the electrode plates 300 is sealed at boundaries between each of the electrode plates 300. The external circumferential surface of each of the electrode plates is provided with a water-cooled power pipe 310 through which cooling water and power can be supplied, a gas pipe 320 through which gas is supplied, and a cooling water discharge pipe 330 through which the cooling water can be discharged. The water-cooled power pipe 310, the gas pipe 320, and the cooling water discharge pipe 330 are spaced apart from each other by predetermined intervals.

The power supply unit 500 further includes a switch 510 for electrically insulating the auxiliary negative electrode plate 400 by switching between the auxiliary negative electrode plate 400 and the negative electrode plate 200.

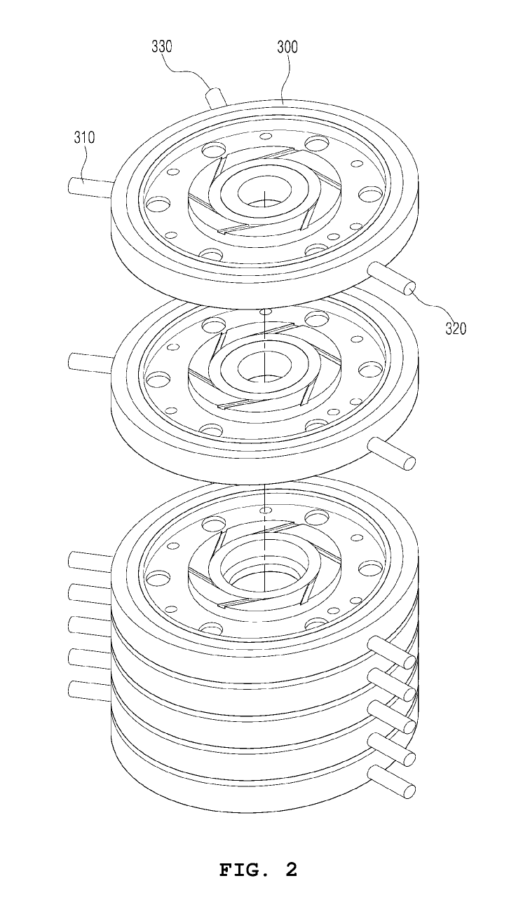

FIG. 2 is a view illustrating a process of assembling the electrode plates according to one embodiment of the present invention.

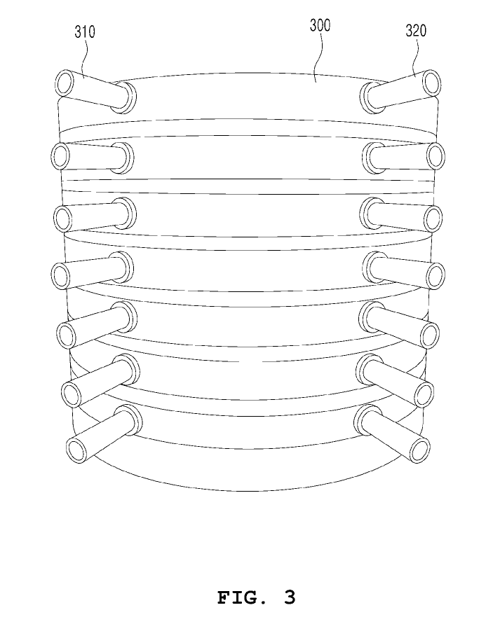

FIG. 3 is a perspective view of the multi-electrode plasma torch according to the embodiment of the present invention.

Referring to FIGS. 2 and 3, an electrode plate pack includes seven electrode plates 300. In one electrode plate pack composed of seven electrode plates 300, the water-cooled power pipes 310 are parallel and are arranged in a row in the vertical direction. The gas pipes 320 and the cooling water discharge pipes 300 are arranged in the same way as the water-cooled power pipes 310. The seven electrode plates 300 can be supplied with cooling water, simultaneously, through the water-cooled power pipes 310. Alternatively, both of cooling water and electric power can be supplied the seven electrode plates, simultaneously, through the water-cooled power pipes 310. The seven electrode plates 300 can be supplied with gas, simultaneously, through the gas pipes 320. Through the cooling water discharge pipes 330, the cooling water can be circulated. That is, the cooling water and electric power are supplied to the electrode plates 300 pack by pack.

The length of an arc can be increased by the number of electrode plates 300. However, when the electrode plates 300 are provided discretely, it takes much time and labor to couple and seal each of the electrode plates 300. Thus, it is preferable to package the multiple electrode plates 300 in a module (i.e., pack), because it reduces the time and cost taken to increase the length of an arc.

However, the number of electrode plates 700 set in a single pack is not limited to seven. The number of electrode plates packaged in a single pack can be determined according to the convenience of consumers.

In addition, since each of the electrode plates 300 has a circular hole at its center, when a plurality of electrode plates 300 is coupled, a long passage is formed at the center of the electrode plates 300 stacked in a pack. Thus, the gas supplied through the gas pipe 320 reliably turns into plasma while passing through an arc column 30 and the plasma can exit a torch nozzle 20.

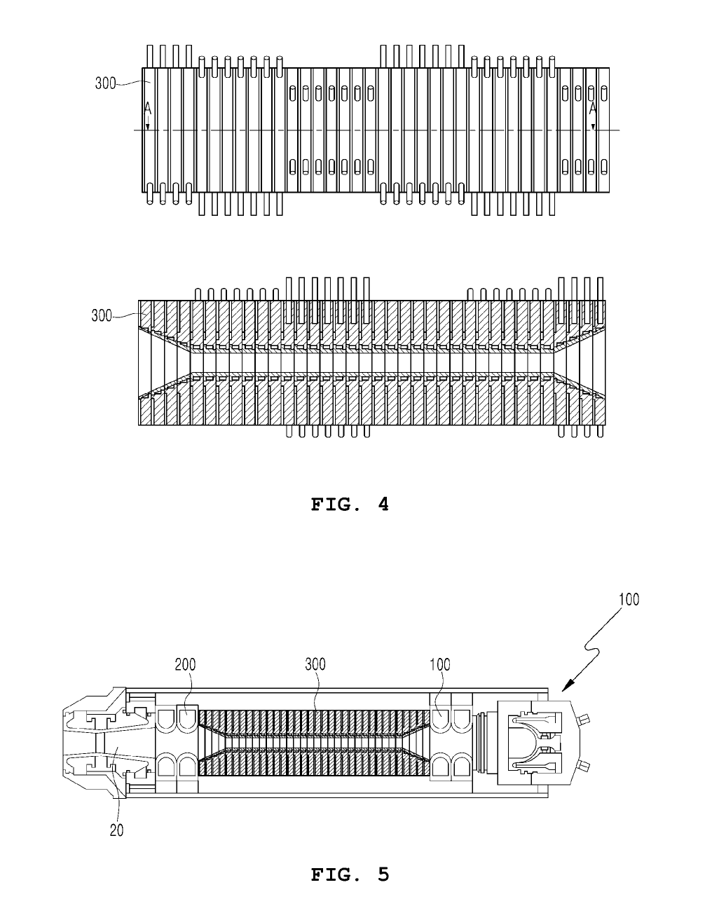

FIG. 4 is a side elevation view illustrating the electrode plates of the multi-electrode plasma torch according to the embodiment of the present invention.

Referring to FIG. 4, seven electrode plates 300 are coupled to form a pack of electrode plates. Undesirable gaps formed between each of the electrode plates 300 are all sealed to prevent the gas from leaking.

The multiple packs of electrodes plates can be coupled to obtain a desired long arc. As described above, in one embodiment of the present invention, one electrode plate pack is composed of seven electrode plates 300, in which among the cooling water pipes 310, the gas pipes 320, and the power pipes 330, the same kind of pipes are arranged side by side in a row. When multiple packs of electrode plates are coupled, as illustrated in FIG. 4, the same kind of pipes, among the cooling water pipes 310, the gas pipes 320, and the electric power pipes 330, are misaligned pack by pack or all aligned for all of the packs. When misaligned, each pack can be easily discernable.

FIG. 5 is a cross-sectional view of the multi-electrode plasma torch according to the embodiment of the present invention.

Among the electrodes plates 300 disposed between the positive electrode 100 and the negative electrode 200, the electrode plate 300 that is adjacent to the positive electrode 100 is set as the auxiliary negative electrode plate 400. This auxiliary negative electrode plate 400 has the opposite polarity to the positive electrode 100. The electrode plate 300 adjacent to the positive electrode 100 is electrically connected in a manner to serve as an electrode like the positive electrode 100 and the negative electrode 100.

A power supply is installed between the positive electrode 100 and the auxiliary negative electrode plate 400 to form the arc column 30 there. The formed arc column 30 heats the gas being supplied through the gas pipe 320 and flowing through the inside of the electrode plates 300, thereby changing the gas into plasma, and the plasma passes the negative electrode 200 and leaves the torch nozzle 200.

The switch 510 is switched between the auxiliary negative electrode plate 400 and the negative electrode 200. When the negative electrode plate 400 is electrically insulated by the switching operation of the switch 510 after the plasma forms a conductive channel, a long arc column 40 can be easily formed between the positive electrode 100 and the negative electrode 200.

Instead of the switching operation of the switch 510, a circuitry resistor (now illustrated) may be used. In this case, not only the auxiliary negative electrode plate 400 can be used as a current path but also it is possible to prevent the increase in the output of the torch 10 through distribution of an electric current by the negative electrode 200 and the auxiliary negative electrode plate 400. This facilitates the output control from a relatively low output power to a relatively high output power.

The same effect can also be obtained even when the rear electrode 100 is used as the negative electrode, the front electrode 200 is used as the positive electrode, and the auxiliary electrode plate 400 is used as an auxiliary positive electrode.

This reversed arrangement will be described in brief. When the positive electrode 200 and the auxiliary positive electrode 400 are electrically connected, the arc column 30 is formed between the negative electrode 100 and the auxiliary positive electrode 400, and the gas passing through the inside of the electrode plates 300 is heated and converted into plasma by the arc column 30. Then, the plasma forms a conductive channel between the positive electrode 200 and the negative electrode 100 while passing the positive electrode 200. Thus, a long arc 40 formed between the two electrodes can be obtained by changing the electrical connection.

Although the preferred embodiments of the present disclosure have been disclosed for illustrative purposes, those skilled in the art will appreciate that various modifications, additions and substitutions are possible, without departing from the scope and spirit of the invention as disclosed in the accompanying claims.

[Explanation of Reference Numerals]

| | |
|---|---|
| 10: Torch | 20: Nozzle |
| 30: Arc column | 40: Long arc column |
| 100: Rear electrode | 200: Front electrode |
| 300: Electrode plate | 310: Water-cooled power pipe |
| 320: Gas pipe | 330: Cooling water discharge pipe |
| 400: Auxiliary electrode plate | 500: Power supply unit |
| 510: Switch | |

1. A plasma torch comprising:
a rear electrode;
a front electrode;
a plurality of electrode plates disposed between the rear electrode and the front electrode;
an auxiliary electrode plate which is one of the plurality of electrode plates, located adjacent to the rear electrode, and having a polarity that is opposite in to a polarity of the rear electrode; and
a power supply unit connected between the rear electrode and the auxiliary electrode plate.

2. The plasma torch of claim 1, wherein:
each of the plurality of electrode plates are of a disk form, and
the plurality of electrode plates are sealed and coupled each other.

3. The plasma torch of claim 1, further comprising:
a cooling water pipe, positioned on an external circumferential surface of each of the plurality of electrode plates, through which cooling water is supplied;
a gas pipe, positioned on an external circumferential surface of each of the plurality of electrode plates, through which gas is supplied; and
a power pipe, positioned on an external circumferential surface of each of the plurality of electrode plates, through which electric power is supplied to the corresponding electrode plate to serve as an electrode,
wherein the cooling water pipe, the gas pipe, and the power pipe are spaced apart from each other by a predetermined interval.

4. The plasma torch of claim 1, wherein further comprising:
a switch, in communication with the power supply unit, to electrically insulate the auxiliary electrode by switching between the auxiliary electrode and the front electrode as necessary.
